(19) United States
(12) Patent Application Publication
(10) Pub. No.: US 2012/0189819 A1
(43) Pub. Date: Jul. 26, 2012

(54) Reinforced Rubber Tile with Laminated Top Layer and Air Cushion Effect

(75) Inventor: Ta-Wei Chang, Zengcheng (CN)

(73) Assignee: UNIROLL ENTERPRISE CO., LTD., Zengcheng (CN)

(21) Appl. No.: 13/013,170

(22) Filed: Jan. 25, 2011

(51) Int. Cl. B32B 5/16; B32B 27/40; B32B 27/06; B32B 37/14; B32B 5/02; B32B 3/30; B32B 7/02; B32B 37/12; B32B 7/12; B32B 3/26

(52) U.S. Cl. 428/172; 428/411.1; 428/423.1; 442/1; 428/218; 428/317.5; 156/62.8

(57) ABSTRACT

An odorless composite floor tile suitable for indoor or outdoor use is formed from elastomer particles. The composite floor tile has a lower layer that is formed by binding a first group of elastomer particles with an adhesive, and is stabilized with meshes of fiberglass fibers. The composite floor tile also has a laminated upper layer. The laminated upper layer is formed by binding a second group of elastomer particles with the adhesive, or formed from synthetic rubber and/or natural rubber, polymeric materials, or fiber materials. The composite floor tile has shock absorption and anti-slippage properties. The composite floor tile has an attractive upper surface that includes a variety of color patterns. Further, the composite floor tile also has a shock absorbing lower layer providing an air cushion effect that is also permeable to air and liquids which reduces or eliminates the breeding and spread of bacteria and mildew.

### TECHNICAL FIELD

This invention relates to systems and methods for flooring, and more specifically, to systems and methods for providing durable, shock absorbing, anti-slippage, and colorful floor surfaces.

### BACKGROUND

Durable floor surfaces that provide good shock absorption and anti-slippage properties are more and more popular, and are used in a variety of application. Such floors may be used in gyms, playgrounds, senior activity centers, as well as other indoor or outdoor facilities where safety is a concern. However, conventional flooring materials that provide such shock absorption and anti-slippage properties often have low density face layers that are porous to the environment, so that such conventional floor materials may be easily worn out and have short service lives. Further, such conventional floor may readily accumulate dirt, mold, and bacteria. The accumulation of dirt, mold, and bacteria may result in unhealthy environments at the facilities where such conventional floor materials are used, and may contribute to the spread of diseases and illnesses at these facilities. Therefore, it would be advantageous to have a floor material that does not have the one or more shortcoming described above.

### SUMMARY

Described herein are systems and methods for providing a composite floor tile that has shock absorption and anti-slippage properties. The composite floor tile has an attractive laminated upper layer that includes a variety of fade-resistant color patterns. The attractive laminated upper layer may be formed from various materials, including elastomers such as natural or synthetic rubber, polymers such as plastic cement, polyvinyl chloride (PVC), polyethylene (PE), polypropylene (PP), polyurethane (PU) composite, and/or other plastics, and fabric such as carpet, or other clothing material (such as khaki). The composite floor tile has anti-mildew and anti-bacteria properties, and is odorless. Thus, compare to conventional floor tiles with dyed colors, the composite floor described herein is more suitable for outdoor use than conventional floor tiles. Nevertheless, the odorless characteristic of the composite floor also makes it especially suitable for indoor use as well.

Further, the composite floor tile also has a shock absorbing lower layer that is joined to the upper layer. The shock absorbing lower layer provides an air cushion effect, The shock absorbing lower layer is also permeable to air and liquids, which reduces or eliminates the breeding and spread of bacteria. The shock absorbing lower layer may have a lower density than the laminated upper layer, in which the upper layer may be formed as a high density rubber sheet with a density 25% to 40% higher than the density of the lower layer. In various embodiments, the lower layer of the composite floor tile is formed by binding a first group of elastomer particles with an adhesive. In some embodiments, the lower layer of the composite floor tile is reinforced with one or more mesh sheets, such as mesh sheets of fiberglass fibers, which provide strength and stabilize the composite floor tile in different environments. The laminated upper layer of the composite floor tile is formed by binding a second group of elastomer particles with the adhesive, formed from a polymeric material, or formed from a fabric material.

In other embodiments, a multi-colored lower layer of the composite floor tile is formed by binding together a first group of elastomer particles with an adhesive. A laminated upper layer of the composite floor tile is formed by binding together a second group of elastomer particles with the adhesive formed from a polymeric material, or formed from a fabric material. The laminated upper layer is formed to present a primary background color and one or more secondary colors that are dispersed throughout the primary background color. The composite floor tile is formed by joining the lower layer with the laminated upper layer.

In additional embodiments, a lower layer of one density is formed by binding a first group of elastomer particles with an adhesive. A laminated upper layer of another density is formed by binding a second group of elastomer particles with an adhesive. The density of the laminated upper layer is greater than the density of the lower layer. The composite floor tile is formed by joining the lower layer with the laminated upper layer.

Thus, the composite floor tile in accordance with the embodiments has exceptional durability, comfort, resilience, density, and stability characteristics. The composite floor tile also exhibits outstanding performance and longevity in multiple environments, such as being slip-resistance even when wet. The composite floor tile provides an environmentally-friendly floor solution that is also easy to install and maintain, and may be used to control the spread of bacteria and dust.

The features, functions, and advantages that have been discussed above or will be discussed below can be achieved independently in various embodiments, or may be combined in yet other embodiments, further details of which can be seen with reference to the following description and drawings.

### BRIEF DESCRIPTION OF THE DRAWINGS

Embodiments in accordance with the teachings of the present disclosure are described in detail below with reference to the following drawings.

FIG. 1 is an isometric view of an exemplary composite floor tile in accordance with various embodiments;

FIG. 2 is a top view of an exemplary composite floor tile in accordance with various embodiments;

FIG. 3 is a bottom view of an exemplary composite floor tile with lower surface protrusions in accordance with various embodiments;

FIG. 4 is a side view of an exemplary composite floor tile with lower surface protrusions in accordance with various embodiments;

FIG. 5 is a bottom view of an exemplary composite floor tile with lower surface cavities in accordance with various embodiments;

FIG. 6 is an isometric view of an exemplary mold that is used to form a lower layer of the composite floor tile, in accordance with various embodiments.

FIG. 7 is a flow diagram illustrating an exemplary process for forming the exemplary composite floor tiles shown in FIGS. 1-5, in accordance with various embodiments.

FIG. 8 is a flow diagram illustrating an exemplary process for forming a lower layer of an exemplar floor composite floor tile that is provided with one or more air chambers, in accordance with various embodiments.

FIG. 9 is a flow diagram illustrating an exemplary process for forming a lower layer of an exemplary composite floor tile that is reinforced with one or more mesh sheets, in accordance with various embodiments.

### DETAILED DESCRIPTION

Described herein are embodiments of a composite floor tile that has shock absorption anti-slippage properties. The composite floor tile include a laminated upper layer that may be from various materials, including elastomers such as natural or synthetic rubber, polymers such as plastic cement, polyvinyl chloride (PVC), polyethylene (PE), polypropylene (PP), polyurethane (PU) composite, and/or other plastics, and fabric such as carpet or other clothing materials, such as khaki. In some embodiments, the laminated upper layer is impermeable or virtually impermeable to dirt, liquids, or other particulate matter. The composite floor tile further includes a shock absorbing lower layer of bound elastomeric particles that is reinforced with one or more mesh sheets, such as mesh sheets of fiberglass fibers, which provide strength and stabilize the composite floor tile in different environment. The shocking absorbing lower layer may have a lower density than the laminated upper layer. In at least one embodiment, the upper layer may be formed as a high density rubber sheet with a density 25% to 40% higher than the density of the lower layer. Thus, in many instances, the composite floor tile may reduce the spread of harmful contaminants during use, while providing an air cushion effect that simultaneously protect personnel or properties from vibrations, shocks, and falls. In some embodiments, the composite floor tile also provides an attractive fade-resistant upper surface that includes a variety of pleasing color patterns, thereby enhancing the aesthetics of the surrounding environments.

Thus, the composite floor tile in accordance with the embodiments has exceptional durability, comfort, resilience, density, and stability characteristics. The composite floor tile also exhibits outstanding performance and longevity in multiple environments, such as being slip-resistance even when wet. The composite floor tile provides an environmentally-friendly floor solution that is also easy to install and maintain, and may be used to control the spread of bacteria, mildew and dust. Further, the composite floor tile is odorless. Thus, compare to conventional floor tiles with dyed colors, the composite floor described herein is more suitable for outdoor use than conventional floor tiles. Nevertheless, the odorless characteristic of the composite floor tile described herein also makes it especially suitable for indoor use as well.

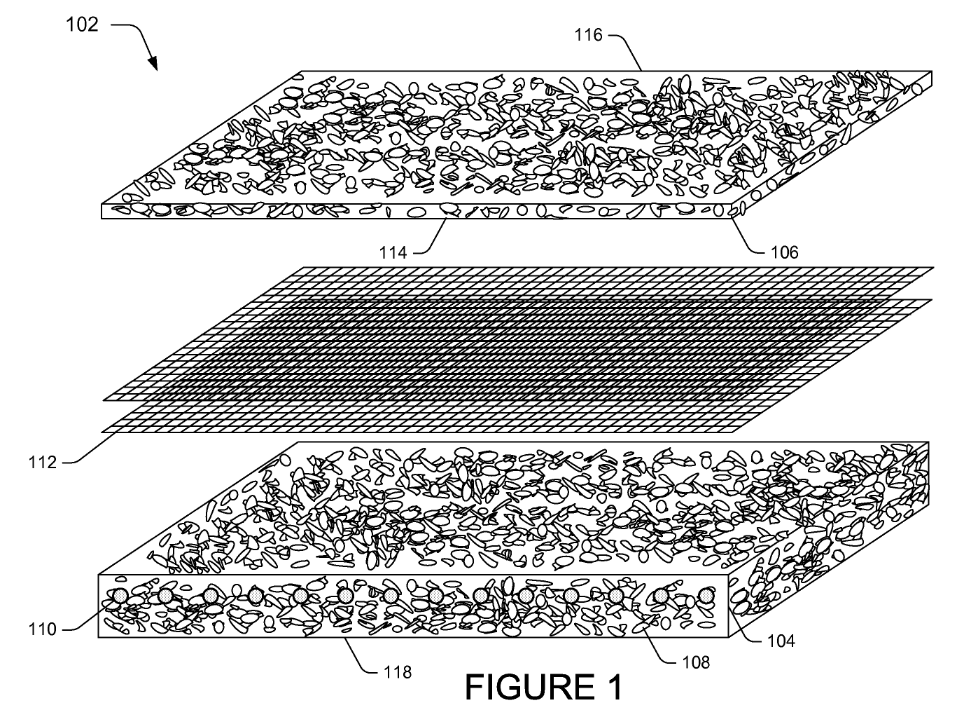

Many specific details of certain embodiments are set forth in the following description and in FIGS. 1-6 to provide a thorough understanding of such embodiments. The present disclosure may have additional embodiments, or may be practiced without one or more of the details described below.

FIG. 1 is an isometric view of an exemplary composite floor tile 102 in accordance with various embodiments. The exemplary composite floor tile 102 includes a lower layer 104 and a laminated upper layer 106. The lower layer 104 may include a plurality of discrete elastomer particles 108 that are bind together with an adhesive. For the purpose of illustration, the proportions of the elastomer particles 108 with respect to the overall dimensions of the composite floor tile 102 are exaggerated. In at least some actual embodiments, each of the elastomer particles 108 may range from 0.2 mm to 0.4 mm in cross-sectional length. The elastomer particles 108 may include natural elastomer particles (e.g., particles that are made from natural rubber or latex), synthetic elastomer particles (e.g., particles that are made from butyl rubber, styrene-butadiene rubber, ethylene propylene rubber, etc.), or a combination of natural and synthetic elastomer particles.

The elastomer particles 108 may be derived from a variety of sources. In some instances, the elastomer particles 108 may be manufactured from recycled rubber products, such as discarded rubber insoles, rubber shoes, rubber boots, and so forth. In such instances, the recycled rubber products may be shredded into uniform-sized or near uniform sized particles to form the elastomer particles 108. In alternative instances, the elastomer particles 108 may be manufactured from new natural or synthetic elastomers. However, in additional instances, the elastomer particles 108 may include both recycled and newly manufactured elastomer particles.

In some embodiments, the elastomer particles 108 that are used to form the lower layer 104 may have the same density or substantially the same density. However, in other embodiments, the elastomer particles 108 may include particles of different density so long as the overall density of the lower layer 104 that is manufactured from the elastomer particles 108 achieves the desired density.

The elastomer particles 108 are bound together with an adhesive to form the lower layer 104. In some embodiments, the adhesive may be a polyurethane-based adhesive. However, any elastomer binding adhesive may be used to bind the elastomer particles 108 into the lower layer 104 in other embodiments. The binding of the elastomer particles 108 with the adhesive into the lower layer 104 may be achieved with the use of a mold. The binding of the elastomer particles 108 with the adhesive may be performed under high temperature and/or high pressure. For example, the adhesive may be cured using a temperature that is higher than the normal room temperature range of 20° C.-25° C. Concurrently or alternatively, the adhesive curing may be achieved when elastomer particles 108 are under a pressure that is higher than one standard atmosphere (1 atm), or 760 Torr. Such pressure may be achieved via the use of a pressure mold that exerts compressive force on every surface of the lower layer 104 being formed.

In some embodiments, the lower layer 104 may be provided with one or more air chambers 110. Each of the air chambers 110 may extend through at least a portion of the lower layer 104 or the entire length of the lower layer 104. Multiple air chambers 110 may be regularly spaced apart in the lower layer 104. As further described below, each of the air chambers may be formed with the insertion of a removable insert during the molding of the elastomer particles 108 with adhesive into the lower layer 104. Thus, upon the removal of a removable insert after curing of the adhesive, a corresponding air chamber 110 is created in the lower layer 104. The air chambers 110 may improve the shock absorption properties of the composite floor tile 102 in the same manner that air pockets in the sole of an athletic shoe cushion a foot from ground impact. Each of the air chambers 110 may have any number of cross-sectional shapes (e.g., circular, oval, square, rectangular, etc.).

In other embodiments, the lower layer 104 is reinforced with one or more mesh sheets 112 that are embedded in the elastomer particles 108 of the lower layer 104. Each of the mesh sheets 112 may include an interwoven matrix of fiber material that has substantially the same or smaller surface dimensions as the lower layer 104 being made. In various embodiments, the interwoven matrix of fiber material may include fiberglass fibers, carbon fibers, and/or polymer fibers. The reinforcement of the lower layer 104 with the one or more mesh sheets 112, such as the fiberglass fibers, may counteract the natural tendency of the elastomer particles 108 to expand and contract in different temperatures, and stabilize the composite floor tile 102 in different environments. For example, a composite floor tile 102 with a lower layer 104 that is reinforced with the mesh sheets 112 may be suited for use in open air facilities, such as public parks, playgrounds, stadiums, etc.

The one or more mesh sheets 112 are embedded into the lower layer 104 during the molding of the lower layer 104 from elastomer particles 108 and the adhesive. The actual number of the mesh sheets 112 that are embedded into the lower layer 104 may be dependent on the desired thickness of the lower layer 104, which may be based on the overall desired thickness of the composite tile 102. For example, a greater number of mesh sheets 112 may be placed into a thicker lower layer 104 than placed into a thinner lower layer 104 in order to achieve the same degree of stability.

In various embodiments, the laminated upper layer 106 may include a plurality of discrete elastomer particles 114 that are also bind together with the elastomer binding adhesive described above. For the purpose of illustration, the proportions of the elastomer particles 114 with respect to the overall dimensions of the composite floor tile 102 are exaggerated. In at least some actual embodiments, each of the elastomer particles 114 may range from 0.2 mm to 0.4 mm in cross-sectional length. The elastomer particles 114 may also include natural elastomer particles, synthetic elastomer particles, or a combination of natural and synthetic elastomer particles from recycled and/or new production sources. The elastomer particles 114 may also be bind together with the elastomer binding adhesive at the temperature and/or the pressure described above during manufacturing. The pressure may be achieved via the use of a pressure mold that exerts compressive force on every surface of the laminated upper layer 106.

In some embodiments, the elastomer particles 114 that are used to form the laminated upper layer 106 may have the same density or substantially the same density. However, in other embodiments, the elastomer particles 114 may include particles of different density so long as the overall density of the laminated upper layer 106 that is manufactured from the elastomer particles 114 achieves the desired density. The laminated upper layer 106 may be formed by binding the elastomer particles 114 with adhesive in a mold. The binding of the elastomer particles 114 with the adhesive may be performed under high temperature and/or high pressure. For example, the adhesive may be cured using a temperature that is higher than the normal room temperature range of 20° C.-25° C. Concurrently or alternatively, the adhesive curing may be achieved when elastomer particles 114 are under a pressure that is higher than one standard atmosphere (1 atm), or 760 Torr. Such pressure may be achieved via the use of a pressure mold that exerts compressive force on every surface of the laminated upper layer 106 being formed. In some embodiments, the production of the laminated upper layer 106 may also include cutting the formed laminated upper layer 106 to match the surface dimensions of the previously formed lower layer 104.

The lower layer 104 and the laminated upper layer 106 may be joined together with an elastomer binding adhesive, such as the polyurethane-based adhesive, that is disposed between the lower layer 104 and the laminated upper layer 106 to form the composite floor tile 102. In this way, the laminated upper layer 106 provides an upper surface 116 for the composite floor tile 102, and the lower layer 104 provides a lower surface 118 for the tile. The lower layer 104 and the laminated upper layer 106 may also be joined together with the adhesive at a high temperature and/or high pressure. For example, the adhesive may be cured using a temperature that is higher than the normal room temperature range of 20° C.-25° C. Concurrently or alternatively, the adhesive curing may be achieved when elastomer particles 108 are under a pressure that is higher than 1 atm.

In some embodiments, the composite floor tile 102 may be formed so that the overall density of the laminated upper layer 106 may be higher than the overall density of the lower layer 104. For example, in at least one embodiment, the density of the lower layer 104 may be 600 kg/m³, while the density of the laminated upper layer 106 may be 700 kg/m³. In other embodiments, the laminated upper layer 106 may be formed as a high-density rubber sheet of synthetic rubber and/or natural rubber with a density that is 25% to 40% denser than the density of the lower layer 104. Further, the lower layer 104 may be formed so that it is thicker than the laminated upper layer 106. For example, in at least one other embodiment, the thickness of the laminated upper layer 106 may be 0.5-2.0 mm, while the thickness of the lower layer may be 18 mm. In such embodiments, the overall thickness of the composite floor tile 102 may be between 12-110 mm.

Thus, the difference in the densities and/or the difference in the thickness of the lower layer 104 and the laminated upper layer 106 may produce a composite floor tile 102 that possesses both favorable shock absorption and contaminant impermeability characteristics. For example, the thicker and lower density lower layer 104 may absorb shocks and vibrations, while the thinner and higher density laminated upper layer 106 may be less porous than the lower layer 104 to reduce or eliminate the penetration of dirt, liquids, or other particulate matter into the upper surface 116 of the composite floor tile 102 during use. As a result, the growth of mold, mildew, or bacteria on the upper surface 116 may be reduced or eliminated. The thinner and higher density laminated upper layer 106 may also enable the composite floor tile to provide a uniform and smooth deformation-resistant surface that also eliminates or reduces slip and fall hazards. Nevertheless, it will be appreciated that the thickness of the lower layer 104 and the laminated upper layer 106 may vary in other embodiments. For example, the thickness of the lower layer 104 may be equal to or less than the thickness of the laminated upper layer 106. Even with such variations in the lower layer 104 and the laminated upper layer 106, the density of the laminated upper layer 106 may still be higher than the density of comparable layers in conventional floor tiles. Accordingly, the composite tile 102 may offer superior durability and anti-slippage properties than conventional floor tiles.

As described above, the elastomer particles for forming the composite floor tile 102 may be recycled products. Accordingly, the source elastomer particles for the elastomer particles 108 and the elastomer particles 114 may be multi-colored elastomer particles. However, in order to achieve an aesthetically pleasing composite floor tile 102, elastomer particles 114 of a single color may be used to form the laminated upper layer 106.

Nevertheless, in other embodiments, the colors of elastomer particles 114 may be selected and blended so that elastomer particles 114 of a particular color predominates in the resultant laminated upper layer 106, while elastomer particles 114 of a predetermined number of colors (e.g., 1-3 colors) are intermixed with the elastomer particles 114 of the predominate color. For example, the laminated upper layer 106 may be formed from predominately black elastomer particles, with some groups of white and yellow elastomer particles intermixed among the black elastomer particles. In this way, the resultant color pattern of the laminated upper layer 106 may have a “night sky” appearance that is both colorful and pleasing to the eye. Thus, since there may be potentially tens of thousands of color designs available, the resulting composite tile 102 may be much more visually appealing than conventional single-color floor tiles.

In contrast, the lower layer 104 is generally not visible when the composite floor tile 102 is installed. As such, the elastomer particles 108 may be elastomer particles of any color blend that is obtained from any source. Accordingly, in at least some embodiments, the elastomer particles 114 that form the laminated upper layer 106 may contain less color variation than the elastomer particles 108 that form the lower layer 104.

However, in other embodiments, the elastomer particles 114 that form the laminated upper layer 106 may contain more color variation than the elastomer particles 108 that form the lower layer 104. In other words, the laminated upper layer 106 that is formed by the elastomer particles 114 may have a greater number of colors than the lower layer 104 that is formed from by the elastomer particles 108. Such embodiments may suit a different aesthetic taste with respect to color patterns for the composite floor tile 102.

In some alternative embodiments, the laminated upper layer 106 is formed from a polymeric material, such polyvinyl chloride (PVC), polycarbonate (PC), polyethylene (PE), plastic cement, polypropylene (PP), and/or other plastics, or from polyurethane (PU) composite. The polymeric material in a laminated upper layer 106 may be of a uniform color, or include polymer particles of different colors that are fused together to produce a variety of different colors in a similar manner as the elastomer particles 114. In other alternative embodiments, the laminated upper layer 106 is formed from natural fabric materials (e.g., wool, cotton, etc), synthetic fabric materials (e.g., polypropylene, fiberglass, etc.), or a blend of natural and synthetic fiber materials. For example, the laminated upper layer 106 may be formed from textile in the form of carpet that includes a layer of pile, textile in the form of khaki, and/or other woven fabric clothing material. The synthetic and/or natural fabric in the laminated upper layer 106 may includes fabric strands of different colors or a uniform color. Accordingly, the fabric may be woven into a uniform color, or woven into different color patterns and different designs. For example, a laminated upper layer 106 formed from the synthetic and/or natural fabric may exhibit similar color variations and designs as a laminated upper layer 106 that is formed from the elastomer particles 114.

In such embodiments, the lower layer 104 and the laminated upper layer 106 may also be joined together with a suitable binding adhesive that is disposed between the lower layer 104 and the laminated upper layer 106 to form the composite floor tile 102.

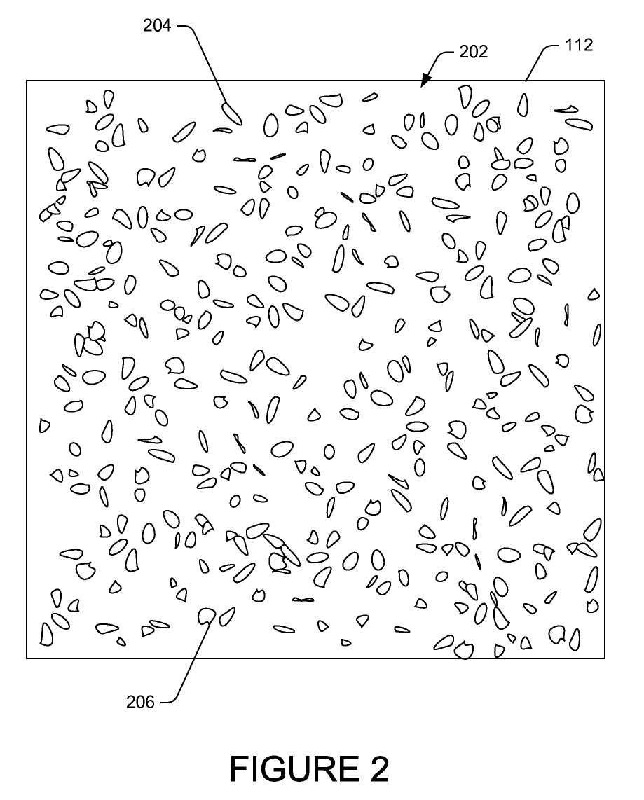

FIG. 2 is a top view of the exemplary composite floor tile 102 in accordance with various embodiments. As shown, the upper surface 116 of the composite floor tile 102 is a surface of the laminated upper layer 106. In some embodiments, the upper surface 116 may include a background 202 that is made up of elastomer particles of a predomination color (e.g., black). Groups of elastomer particles of a first color (e.g., white), such as an elastomer particles 204, and groups of elastomer particles of a second color (e.g., yellow), such as an elastomer particles 206, are dispersed throughout the background 202. In other embodiments, the upper surface 106 may be formed from polymers or fabrics that exhibit similar designs as formed by the elastomer particles 204 and 206, as well as other designs and patterns.

As further shown, the composite floor tile 102 may be a square tile in at least one embodiment. For example, the composite floor tile 102 may have a width of 50 cm and a length of 50 cm. Nevertheless, the composite floor tile 102 may be of any shape (e.g., rectangle, triangle, hexagon) and any dimension (e.g., 40 cm by 60 cm) in other embodiments provided that multiples of the composite floor tile 102 of a single shape, or a combination of shapes, may be fitted together to cover a surface without leaving any holes.

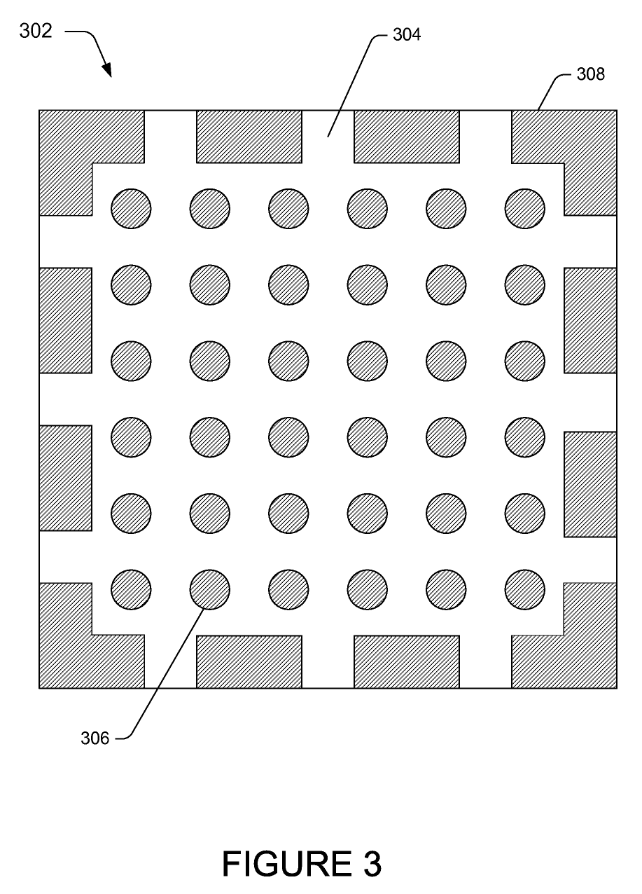

FIG. 3 is a bottom view of an exemplary composite floor tile 302 with lower surface protrusions in accordance with various embodiments. The composite floor tile 302 may be manufactured using the same materials and techniques as the composite floor tile 102. However, the composite floor tile 302 may include protrusions on a lower layer 304. The lower layer 304 may be similar to the lower layer 104 of the composite floor tile 102. The protrusions may be formed by pressing a portion of a pressure mold with a negative impression of the protrusions against a surface of the lower layer 34 during the binding of the elastomer particles 108 with the elastomer binding adhesive. The protrusions may be in the form of circular studs, such as circular stud 306 and perimeter tabs, such as the perimeter tab 308. Thus, when the composite floor tile 302 is positioned on top of an underlying substrate (e.g., subfloor), the protrusions may enhance the grip ability of the composite floor tile 302 against the underlying substrate by providing edges that resist slippage of the composite floor tile 302 on the underlying substrate. Additionally, the protrusions may also promote the circulation of air underneath the composite floor tile 302, thereby reducing the accumulation of moisture that may contribute to mold or bacterial growth. It will be appreciated that while a particular pattern of the surface protrusions (e.g., a combination of circular studs 306 and perimeter tabs 308) is shown in FIG. 3, other patterns of protrusions may be implemented for the composite floor tile 302 in additional embodiments. These protrusion patterns may be implemented so long as the protrusion patterns do not affect the stability or the deformation-resistance of the composite floor tile 302.

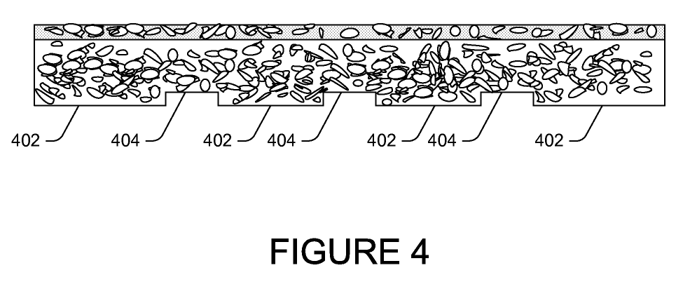

FIG. 4 is a side view of the exemplary composite floor tile 302 with lower surface protrusions in accordance with various embodiments. As shown, the protrusions 402 may form recesses 404 underneath the composite floor tile 302 when the tile is placed on the underlying substrate (e.g., subfloor). As described above, the protrusions 402 may enhance the slippage-resistance of the composite floor tile 302 against the underlying substrate. The recesses 404 may promote air circulation underneath the composite floor tile 302.

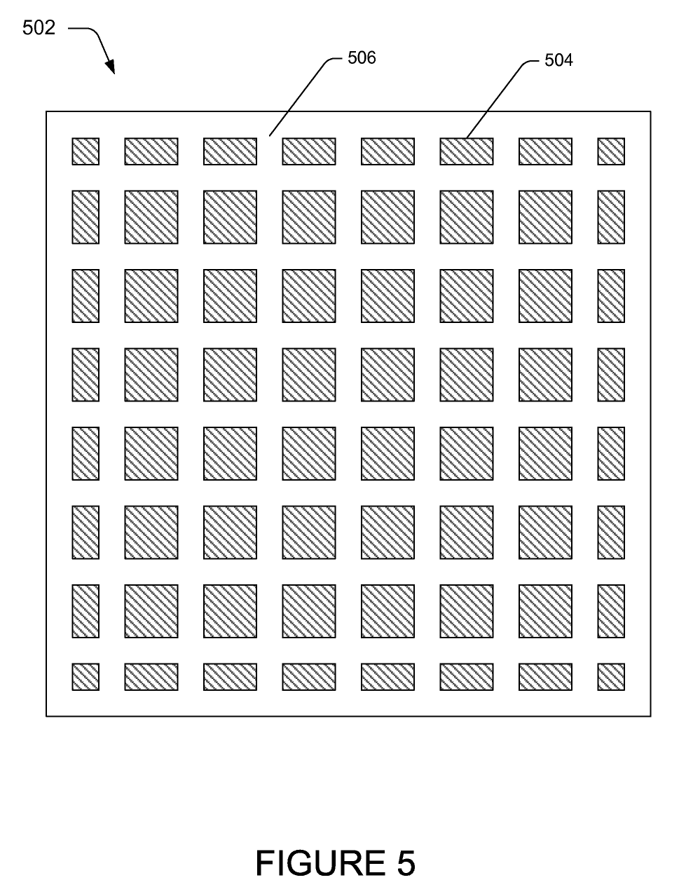

FIG. 5 is a bottom view of an exemplary composite floor tile 502 with lower surface cavities in accordance with various embodiments. The composite floor tile 502 may be manufactured using the same materials and techniques as the composite floor tile 102. However, the composite floor tile 502 may include cavities, such as the cavity 504, which at least partially penetrate into a lower layer 506 of the composite floor tile 502. The lower layer 506 may be similar to the lower layer 104 of the composite floor tile 102. The cavities on the lower layer 506 may be formed by pressing a portion of a pressure mold with a positive impression of the lower surface cavities against a surface of the lower layer 506 during the binding of the elastomer particles 108 with the elastomer binding adhesive.

Thus, when the composite floor tile 502 is positioned on top of an underlying substrate (e.g., subfloor), the lower surface cavities may enhance the grip ability of the composite floor tile 502 against the underlying substrate by providing edges that resist slippage of the composite floor tile 502 on the underlying substrate. Additionally, the cavities may reduce the weight of the composite floor tile 502 without affecting the structural strength of the composite floor tile 502. The reduced weight of the composite floor tile 502 may make it easier to install or remove the composite floor tile 502.

It will be appreciated that while a particular honeycombed box pattern of the cavities is shown in FIG. 5, other patterns of cavities may be implemented for the composite floor tile 502 in additional embodiments. These cavity patterns may be implemented so long as the patterns do not affect the structural rigidity or the deformation-resistance of the composite floor tile 502.

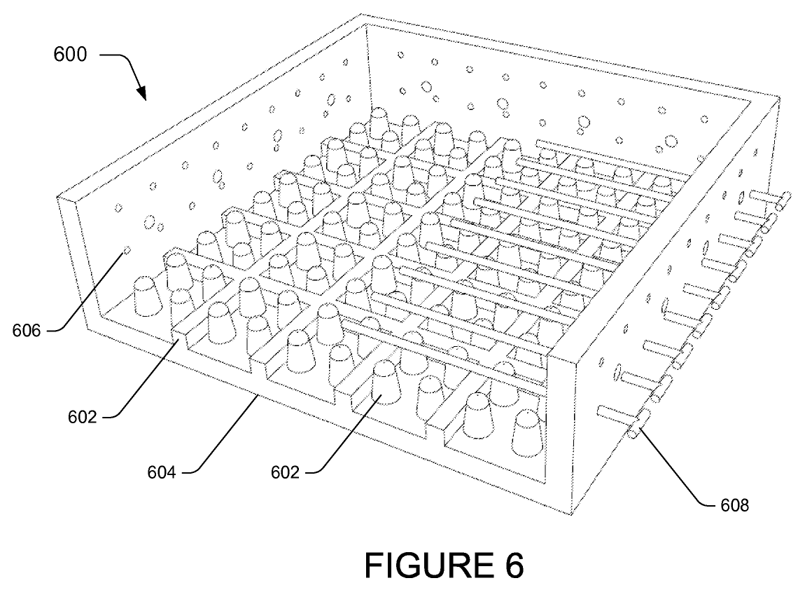

FIG. 6 is an isometric view of an exemplary mold 600 that is used to form a lower layer of a composite floor tile, in accordance with various embodiments. For the sake of illustration clarity, a front side and a top cover of the mold 600 are not shown in FIG. 6. Elastomer particles 108 and an adhesive may be placed in the mold 600 to form a lower layer of a composite floor tile, such as the lower layer 104. The mold 600 includes one or more projections 602 on its bottom side 604. The projections 602 may form one or more projections patterns. The one or more projections are used to produce the one or more protrusions (e.g., protrusions 402) and/or one or more cavities (e.g., cavity 504) that are present on the lower surface 118 of the lower layer 104.

The mold 600 also includes one or more side openings 606 that receive corresponding removable inserts 608. As shown, each of the one or more removable inserts 608 may be a cylindrical rod that is inserted into the mold 600 during the placement of the elastomer particles 108 and an adhesive into the mold 600. Accordingly, upon curing of the adhesive, the removable inserts 608 are removed to form the air chambers 110. Further, one or more mesh sheet 112 may be embedded in the elastomer particles 108 that are placed into the mold 600 prior to the insertion of at least some of the removable inserts 608. Alternatively, one or more mesh sheets 112 may be embedded in the elastomer particles 108 before or following the placement of all the removable inserts 608 in the elastomer particles 108 for forming the air chambers 110.

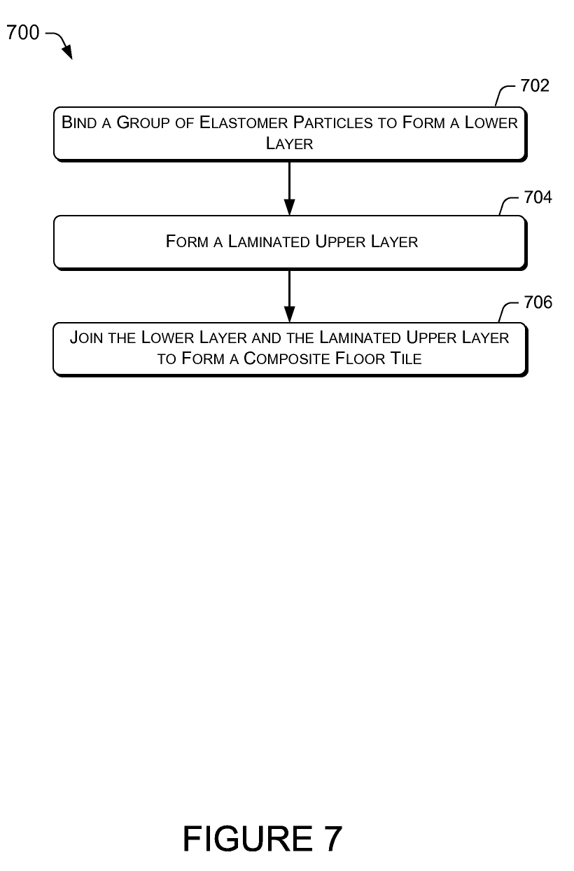

FIGS. 7-9 are flow diagrams that illustrate exemplary processes related to the formation of the exemplary floor tiles shown in FIGS. 1-5. The order in which the operations are described in each of the figures is not intended to be construed as a limitation, and any number of the described blocks can be combined in any order and/or in parallel to implement the process.

FIG. 7 is a flow diagram illustrating an exemplary process 700 for forming the exemplary composite floor tiles shown in FIGS. 1-5, in accordance with an embodiment.

At block 702, a group of the elastomer particles 108 are bind together to form a lower layer, such as the lower layer 104. In various embodiments, the elastomer particles 108 may include natural elastomer particles, synthetic elastomer particles, or a combination of natural and synthetic elastomer particles from recycled and/or new production sources. In some embodiments, the elastomer particles 108 may be bind together with an elastomer binding adhesive at a temperature that is higher than a normal room temperature range and/or a pressure that is higher than 1 atm. In some embodiments, a pressure mold with a positive or negative impression may be used to respectively provide the lower layer 104 with at least one protrusion or at least one cavity at a surface of the lower layer 104. In some embodiments, the formed lower layer may be provided with the one or more air chambers 110 and/or reinforced with the one or more mesh sheets 112.

At block 704, a laminated upper layer is formed. In some embodiments, another group of the elastomer particles 114 are bind together to form a laminated upper layer, such as the laminated upper layer 106. In various embodiments, the elastomer particles 114 may include natural elastomer particles, synthetic elastomer, or a combination of natural and synthetic elastomer particles from recycled and/or new production sources. In some embodiments, the elastomer particles 114 may be bind together with an elastomer binding adhesive at a temperature that is higher than a normal room temperature range and/or a pressure that is higher than 1 atm. The laminated upper layer 106 that is formed from the elastomer particles 114 may have a higher density than the lower layer 104 that is formed from the elastomer particles 108. In at least one embodiment, the laminated upper layer 106 may be formed as a high-density rubber sheet of synthetic rubber and/or natural rubber with a density that is 25% to 40% denser than the density of the lower layer 104. Further, the elastomer particles 114 that form the laminated upper layer 106 may contain less color variation or more color variation than the elastomer particles 108 that form the lower layer 104.

In other embodiments, the laminated upper layer 106 is formed from a polymeric material, such polyvinyl chloride (PVC), polycarbonate (PC), polyethylene (PE), plastic cement, polypropylene (PP), and/or other plastics, or from polyurethane (PU) composite. In additional embodiments, the laminated upper layer 106 is formed from natural fiber materials (e.g., wool, cotton, etc), synthetic fiber materials (e.g., polypropylene, fiberglass, etc.), or a blend of natural and synthetic fiber materials. For example, the laminated upper layer 106 may be formed from textile in the form of carpet that includes a layer of pile, denim, khaki, and/or other woven fabric clothing material. The laminated upper layer 106 that is formed from the polymeric material or the fiber material may contain less color variation or more color variation than the lower layer 104 that is formed from the elastomer particles 108.

At block 706, the lower layer 104 and the laminated upper layer 106 are bound together to form a composite floor tile, such as the composite floor tile 102. In various embodiments, the lower layer 104 and the laminated upper layer 106 are joined together with an elastomer binding adhesive at a temperature that is higher than a normal room temperature range and/or a pressure that is higher than 1 atm. The resulting composite floor tile may include an upper surface, such as the upper surface 116, which is form by a surface of the laminated upper layer 106. The resulting composite floor tile 102 may also include a lower surface, such as the lower surface 118, which is formed by a surface of the lower layer 104. In some embodiments, rather than a smooth and uniform lower surface 118, the lower surface 118 of the composite floor tile 102 may include at least one protrusion or at least one cavity.

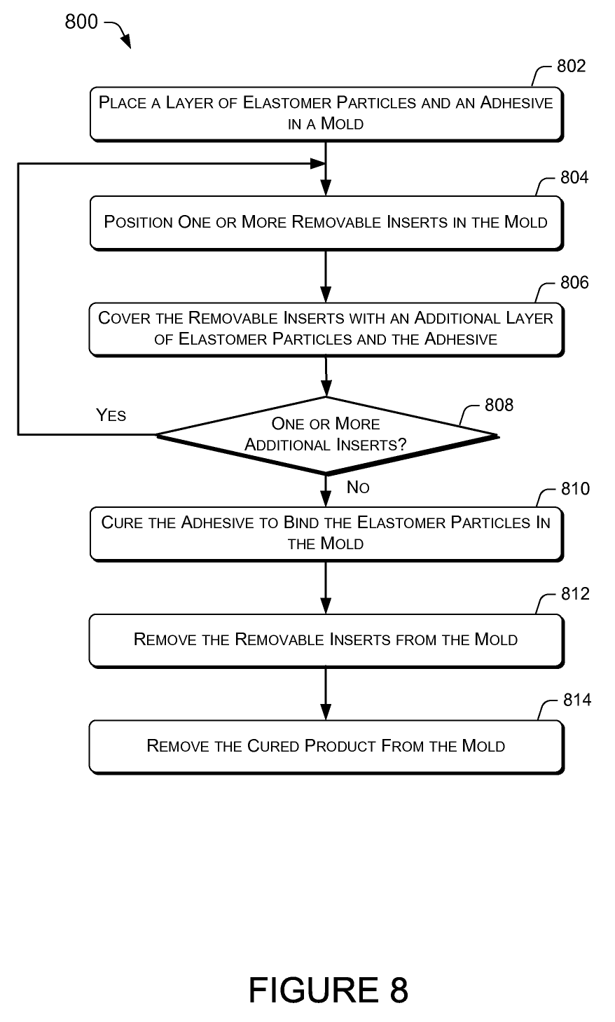

FIG. 8 is a flow diagram illustrating an exemplary process 800 for forming a lower layer 104 of the composite floor tile 102 that is provided with one or more air chambers, in accordance with various embodiments. The exemplary process 800 further illustrates block 702 of the process 700. Further, at least some operations of the process 800 may be implemented concurrently with the exemplary process 900 described below.

At block 802, a layer of elastomer particles 108 and an adhesive is placed in a mold, such as the mold 600. At block 804, one or more removable inserts 608 may be positioned into the mold. Each of the removable inserts is for forming a corresponding air chamber 110 in the finished lower layer 106. At block 806, the removable inserts 608 are covered with an additional layer of elastomer particles and the adhesive.

At decision block 808, a determination is made as to whether one or more additional removable inserts 608 are to be inserted into the mold and positioned within the elastomer particles 108. Thus, if it is determined that one or more additional removable inserts 608 are to be inserted into the mold (“yes” at decision block 808), the process 800 may loop back to block 804, so that on the one or more additional removable inserts 608 are inserted into the mold and covered with another layer of elastomer particles and the adhesive.

However, if it is determined that no other removable inserts 608 are to be inserted into the mold (“no” at decision block 808), the process 800 may proceed to block 810. At block 810, the adhesive is cured to bind the elastomer particles 108. At block 812, the removable inserts 608 are removed from the mold. At block 814, the cured product in the form of the lower layer 104 is removed from the mold.

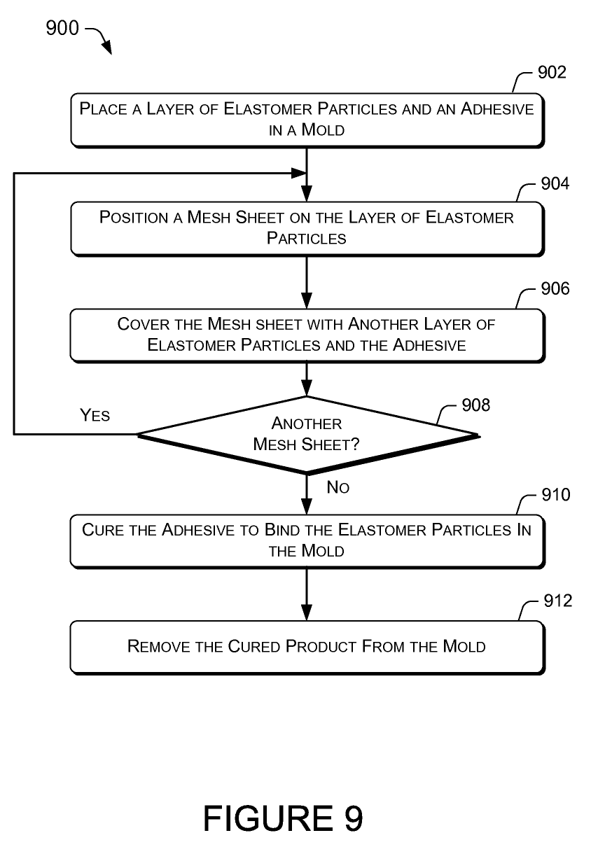

FIG. 9 is a flow diagram illustrating an exemplary process for forming a lower layer 104 of the composite floor tile that is reinforced with one or more mesh sheets, in accordance with various embodiments. The exemplary process 900 further illustrates block 702 of the process 700. Further, at least some operations of the process 900 may be implemented concurrently with the exemplary process 900 described above.

At block 902, a layer of elastomer particles and an adhesive is placed in a mold, such as the mold 600. At block 904, a mesh sheet 112 is positioned in on the layer of the elastomer particles 108. At block 906, the mesh sheet 112 is covered with another layer of elastomer particles and the adhesive.

At decision block 908, a determination is made as to whether additional mesh sheets 112 are to be embedded with the elastomer particles 108. In various embodiments, the number of mesh sheets 112 that is to be embedded may be dependent on the desired thickness of the lower layer 104. Thus, if it is determined that another mesh sheet 112 is to be embedded (“yes” at decision block 908), the process 900 may loop back to block 904, so that another mesh sheet 112 is positioned in place and covered with another layer of elastomer particles and the adhesive.

However, if it is determined that no other mesh sheet 112 is to be embedded (“no” at decision block 908), the process 900 may proceed to block 910. At block 910, the adhesive is cured to bind the elastomer particles 108. At block 912, the cured product in the form of the lower layer 104 is removed from the mold.

The composite floor tile in accordance with the various embodiments may reduce the spread of harmful containments and bacterial during usage, while simultaneously protect personnel or properties from vibrations, shocks, and falls. Further, the composite floor tiles in accordance with the embodiments may provides an attractive upper surface that includes a variety of pleasing fade-resistance color patterns, thereby enhancing the aesthetics of the surrounding environments. As such, when compared to conventional floor tiles with dyed colors, the composite floor in accordance with the embodiments is more suitable for outdoor use than conventional floor tiles. Nevertheless, the odorless characteristic of the composite floor tile in accordance with the embodiments also makes it especially suitable for indoor use as well.

Thus, the composite floor tile in accordance with the embodiments has exceptional durability, comfort, resilience, density, and stability characteristics. The composite floor tile also exhibits outstanding performance and longevity in multiple environments, such as being slip-resistance even when wet. The composite floor tile provides an environmentally-friendly floor solution that is also easy to install and maintain, and may be used to control the spread of bacteria, mildew, and dust.

While embodiments of the invention have been illustrated and described above, many changes can be made without departing from the spirit and scope of the invention. Accordingly, the scope of the invention is not limited by the disclosure of these embodiments. Instead, the invention should be determined entirely by reference to the claims that follow.

What is claimed is:

1. A composite floor tile, comprising:
a lower layer that includes a first plurality of elastomer particles that are bound together by an adhesive; and
a laminated upper layer attached to the lower layer that is formed from a second plurality of elastomer particles that are bound together by the adhesive, a polymeric material, or a fiber material.

2. The composite floor tile of claim 1, wherein the lower layer and the laminated upper layer are joined by the adhesive.

3. The composite floor tile of claim 1, wherein each of the first plurality of elastomer particles and the second plurality of elastomer particles include multi-colored elastomer particles.

4. The composite floor tile of claim 1, wherein the first plurality of elastomer particles are of a first number of colors and the second plurality of elastomer particles are of a second number of colors that is less than or greater than the first number of colors.

5. The composite floor tile of claim 1, wherein the adhesive is a polyurethane-based adhesive.

6. The composite floor tile of claim 4, wherein the laminated upper layer forms a rubber sheet with a density that is 25% to 40% higher than a density of the lower layer.

7. The composite floor tile of claim 1, wherein the lower layer includes at least one protrusion or at least one cavity facing away from the laminated upper layer.

8. The composite floor tile of claim 1, wherein the lower layer includes one or more air chambers that provides shock absorption via an air cushion effect, one or more embedded mesh sheets of fiberglass fibers that provide stability to the first plurality of the elastomer particles of the lower layer, or a combination thereof.

9. The composite floor tile of claim 1, wherein the second plurality of elastomers include elastomer particles of a primary color that form a background color of the laminated upper layer, and groups of elastomer particles of one or more secondary colors that are intermixed with the elastomer particles of the primary color.

10. A method, comprising:
binding a plurality of elastomer particles with an adhesive to form a lower layer having multiple colors;
forming a laminated upper layer having a primary background color and one or more secondary colors that are dispersed throughout the primary background color; and
joining the lower layer and the laminated upper layer to form a composite floor tile.

11. The method of claim 10, wherein the forming includes forming the laminated upper layer from an additional plurality of elastomer particles that are bound with the adhesive, forming the laminated upper layer from a polymeric material, or forming the laminated upper layer from a fiber material.

12. The method of claim 11, wherein the elastomer particles are synthetic rubber natural rubber, or a combination thereof, the polymeric material is one of polyvinyl chloride (PVC), polyethylene (PE), polypropylene (PP), polyurethane (PU) composite, or plastic cement, and the fiber material is one of carpet or khaki.

13. The method of claim 10, wherein the binding the plurality of elastomer particles includes forming a lower layer that includes at least one protrusion or at least one cavity.

14. The method of claim 10, wherein the binding the plurality of elastomer particles includes embedding one or more mesh sheets of fiberglass fibers in the plurality of elastomer particles.

15. The method of claim 10, wherein the binding the plurality of elastomer particles includes forming one or more air chambers in the lower layer that provide an air cushioning effect.

16. The method of claim 11, wherein the binding the plurality of elastomer particles or the binding the additional plurality of elastomer particles includes curing the adhesive using at least one of a temperature that is higher than an ambient room temperature or a pressure that is higher than one standard atmosphere.

17. A method, comprising:
binding a first plurality of elastomer particles with an adhesive to form a lower layer of a first density;
binding a second plurality of elastomer particles with the adhesive to form a laminated upper layer of a second density that is greater than the first density; and
joining the lower layer and the laminated upper layer to form a composite floor tile.

18. The method of claim 17, wherein the binding the first plurality of elastomer particles further comprises;
placing a layer of elastomer particles of the first plurality of elastomer particles and the adhesive into a mold;
positioning one or more removable inserts in the mold;
covering the removable inserts with an additional layer of elastomer particles of the first plurality of elastomer particles and the adhesive;
curing the adhesive to bind the first plurality of elastomer particles into the lower layer;
removing the removable inserts from the mold; and
removing the lower layer from the mold.

19. The method of claim 17, wherein the binding the first plurality of elastomer particles further comprises:
placing a layer of elastomer particles of the first plurality of elastomer particles and the adhesive into a mold;
positioning a mesh sheet of fiberglass fibers on the layer of elastomer particles;
covering the mesh sheet with an additional layer of elastomer particles of the first plurality of elastomer particles and the adhesive;
curing the adhesive to bind the first plurality of elastomer particles into the lower layer; and
removing the lower layer from the mold.

20. The method of claim 17, wherein the laminated upper layer formed by the binding of the first plurality of elastomer particles has less color variation or more color variation than the lower layer formed by the binding of the second plurality of elastomer particles.
